(19) United States
(12) Patent Application Publication
(10) Pub. No.: US 2010/0258988 A1
(43) Pub. Date: Oct. 14, 2010

(54) Embodiments of Lateral Displacement Shock Absorbing Technology and Applications Thereof

(75) Inventors: Eric Darnell, South Strafford, VT (US); William H. Brine, III, Hopkinton, MA (US); Stephen D. Moore, Liverpool, NY (US); Joel Robinson, Oswego, NY (US)

Correspondence Address: H. JAY SPIEGEL - H. JAY SPIEGEL & ASSOCIATES, P.O. BOX 11, MOUNT VERNON, VA, 22121, US

(73) Assignee: Sport Helmets, Inc.

(21) Appl. No.: 12/659,544

(22) Filed: Mar. 12, 2010

Related U.S. Application Data
(63) Continuation-in-part of application No. 11/229,626, filed on Sep. 20, 2005, now Pat. No. 7,677,538.

(51) Int. Cl. F16F 7/00; F16F 3/08

(52) U.S. Cl. 267/141

(57) ABSTRACT

Lateral displacement shock absorbing arrays include features allowing them to be effectively installed in environments including helmets having arcuate surfaces. Slotted webbing between adjacent tubes permits their respective axes to tilt with respect to one another to accommodate helmet shape. In this way, the slotted webbing permits each tube to assume an orientation with its axis perpendicular to a tangent to the outer surface of the helmet at that location so that the tube is best aligned with likely impacts. Plural arrays may be assembled together in numerous ways including using a piece of material to which they may be affixed through any one of numerous ways including tabs and slots, posts and holes, stapling, adhesives, laminating, and integrally molding the arrays and material as a one piece assembly. A variety of peripheral shapes for the tubes of the arrays are also contemplated as are numerous materials of construction.

This application is a Continuation-in-Part of application Ser. No. 11/229,626, filed Sep. 20, 2005.

### BACKGROUND OF THE INVENTION

The present invention relates to embodiments of lateral displacement shock absorbing technology and applications thereof. The present invention relates to a new way to attenuate impacts using tubular structures having non-uniform wall cross-sections preferably placed with their axes of elongation parallel to the direction of impact.

The objective achieved through operation of an impact attenuating material is absorption and dissipation of energy. This is accomplished when one object impacts another by slowing down the movement of the first object in a controlled manner. During the process of energy absorption, the impact attenuating material is compressed.

The degree of impact absorption achievable by an impact attenuating material is directly related to the difference between the pre-impact thickness and the thickness of the material when compressed to the maximum degree. Impact absorbing materials known in the prior art such as expanded polystyrene, expanded polypropylene, air bladders, and others bottom out when the input energy exceeds the ability of the impact absorbing material to further deform or crush. When the material bottoms out, further compression does not occur and, once bottoming out occurs, all of the further benefits of impact attenuation are gone.

For example, in the case of a material having a nominal pre-impact thickness of one inch, the material bottoms out with a thickness of 0.35 inches. Thus, only 0.65 inches of the material or 65% of it participate in the attenuation process. The remaining distance (0.35 inches) consists of the material stacking up and getting in its own way.

The science concerning use of impact attenuating materials to absorb energy is well known. Generally speaking, by varying the density and thickness of any given impact attenuating material, differing amounts of energy are capable of being absorbed. The challenge facing designers of impact attenuating products is to appropriately balance the criteria of thickness, stiffness, configuration, i.e., flat, arcuate, etc., and energy absorbing characteristics of a product so that the product is effective structurally, cost effective, as well as commercially viable. Thus, for example, numerous impact attenuating materials might be effective in attenuating impacts on an athlete wearing a helmet. However, if the initial thickness of the impact attenuating material is too high, this requires the helmet to be made with an outer shell that is too large in dimensions to be commercially viable regardless of the price or efficiency of impact attenuation.

Additionally, there is a need for impact attenuating materials that conform to surfaces of varying configurations, such as flat surfaces as well as arcuate or somewhat spherical surfaces such as found within a helmet.

Generally speaking, consumers demand relatively smaller and lighter products. Thus, in an athletic helmet, it is important to conform the outer shell of the helmet as closely as possible to the head of the athlete and for the impact attenuating materials to work effectively in that environment.

Helmet designers typically attempt to design a helmet that will reduce the risk of a broad range of injuries from mild traumatic brain injury (MTBI) to death, and for use in a wide range of activities such as from baseball to lacrosse to football to motor sports. The designers attempt to anticipate the kinds of impact energies that are most likely to occur and to design the helmet to preclude or at least minimize the likelihood of serious injuries from such impacts. The challenge in designing such a helmet is, again, to manufacture the helmet in a size that most optimally conforms to the size of the head that is to be protected thereby. Helmet designs are necessarily a compromise. Impact attenuation is tuned to absorb the type of energy that is most likely to result in permanent or catastrophic injury as a result of a specific activity. Thus, for example, motorcycle helmets are made extremely stiff because they are tuned to attenuate high energy impacts that result from road crashes. By contrast, football helmets are designed “softer” because they are tuned to the energy that results from players colliding together.

To achieve the combination of attenuation of both life threatening and non-life threatening energy levels, a helmet would have to be 1.5 to 2 times the thickness of one that was designed to only protect from life threatening events. A helmet designed to protect a user from MTBI events and not intended to address higher life threatening energies would be thin, but would be seen as unacceptable to the user because it would not adequately reduce the risk of catastrophic injury or death.

In order to achieve a broad range of input energies, the impact attenuating material must be made extremely thick. If a helmet designer chooses to design a helmet intended to absorb high energy impacts, a high density material would be used. If the same designer desired to achieve low energy absorption, a low density material would be employed. If the designer intended to achieve high and low energy absorption, thick materials would be required. All of these parameters and criteria are factored together and a suitable compromise is achieved for each intended activity and the required protection from impacts that typically occur when engaged in such activity.

Additionally, the particular configuration of the impact attenuating materials may have a bearing on its effectiveness.

### SUMMARY OF THE INVENTION

The present invention relates to embodiments of a lateral displacement shock absorbing technology and applications thereof.

The present invention includes the following interrelated objects, aspects and features:

(1) In a first aspect, the present invention contemplates a structure consisting of a plurality of elongated tubular impact absorbing members, each having an axis of elongation. The axes of elongation of the respective tubular members may be parallel to one another. The tubular members are held together by virtue of web means or webbing, laterally extending from the sides of each tubular member, and interconnecting them together.

In one variation, the web means or webbing retains the tubes or tubular members with their axes in parallel relation. In other variations, the webbing may be slotted at the top, bottom, or both, to allow the respective axes of the tubular members to be in other than parallel relation. Such a configuration may be extremely useful where the inventive impact attenuating materials are installed within a helmet having a generally spherical configuration. By permitting the axes of adjacent tubes or tubular members to be other than parallel with one another, each tube can have its axis perpendicular to a tangent of the surface of the helmet at that location to more effectively attenuate impacts.

(2) Each of the tubular members, in the preferred embodiment, consists of an outer surface made up of two frustoconical surfaces with their larger diameter ends abutting one another and their smaller diameter ends facing away from one another. Each tubular member includes a passageway therethrough defined by two frustoconical shapes with the smaller diameter ends abutting one another, and the larger diameter ends facing away from one another and defining the openings of each passageway. The outer surfaces of the tubular members may, if desired, be ribbed.

(3) In considering a frustoconical surface, by definition, that surface is tapered. In accordance with the teachings of the present invention, the range of taper of the outer surface of each tubular member is from 1 to 45 degrees.

(4) While the preferred embodiment of the present invention contemplates tubular members having a circular cross-section, other cross-sections are suitable for use in accordance with the teachings of the present invention. Thus, polygonal cross-sections such as square, pentagonal, hexagonal, octagonal are equally usable as the cross-sections for the tubular members as are elliptical and non-polygonal, so long as the concept of an elongated tube with a central passageway is retained.

(5) The inventive material may be made of any desired effective material such as, for example, thermoplastics including polypropylene, urethanes, and rubber, foam materials such as foamed polyethylene.

(6) In operation, upon impact, the side walls of the tubular members bulge or displace laterally to absorb impacts. The taper of the walls and the open space within the tubular members allow the energy absorbing material to displace laterally allowing a greater range of travel, thus allowing a designer to use less material to obtain equally effective attenuation as compared to traditional materials. A sheet of material according to the teachings of the present invention, with a 1/16″ side wall thickness is able to crush to a vertical thickness of ⅛″, giving active attenuation from full vertical thickness to ⅛″ crushed thickness.

(7) When the present invention is manufactured using resilient materials, the invention exhibits multi-impact characteristics. The side wall shape and design along with material selection cause the material to absorb and dampen the impact rather than acting like a spring and rebounding the energy. Dampened rebound is important so that the material does not act like a bouncing ball and just return the energy to the object being shielded from inputted energy.

(8) The fact that each tubular member is centrally open facilitates enhanced ventilation of an athletic helmet from outside the helmet to the location of the user's head. Airflow through the tubular members easily occurs to enhance ventilation and keep the interior of the helmet relatively cooler.

(9) In the preferred embodiment of the present invention, the degree of taper of the inner and outer surfaces of the tubular members consist of mirror images of one another. However, if desired, the tapers of the inner and outer surfaces of the tubular member may differ.

(10) The shock absorbing material may be manufactured using injection molding, casting, compression molding, match molding, drape molding or may be machined from a wide variety of thermoplastic, rubber, and foamed materials as well as metallic, composite and ceramic materials.

(11) In one application of the impact attenuation material of the present invention, particular sets of tubes held together by suitable webbing are provided in arrays of seven or ten tubes. Each array has opposed ends that have tabs extending laterally outwardly therefrom. Of course, each array may have only one tab if desired. In a situation in which a plurality of arrays are to be installed within a helmet, in one embodiment, a sheet of material cut into a desired pattern is also provided with a plurality of spaced slots or holes designed to receive the tabs of the arrays therethrough. In this way, the arrays may easily be installed on the sheet of material which may then be placed within a helmet so that the arrays are installed at the appropriate locations for most efficient fit on the wearer and most effective shock attenuation. In one embodiment, the sheet of material is transparent which helps assist in the installation process by allowing the installer to see through the sheet of material and into the helmet to best facilitate alignment of the sheet of material with the arrays of tubes affixed thereto during installation.

(12) In installing a plurality of arrays of tubes or tubular members within a helmet, once the tubes are installed in the helmet as mounted on the sheet of material with slots or holes in it to receive the tabs of the arrays, in one embodiment, a comfort liner may comprise a multi-density foam material placed over the exposed ends of the tubes to facilitate spreading forces impacting the helmet over a greater surface area and to preclude the ends of the tubes from directly impacting the head of the user. In a preferred embodiment, the foam material of the comfort liner preferably has a lower density near the head of the wearer and a higher density nearer to the exposed ends of the tubes to help protect the wearer's head from being impacted directly by the ends of the tubes.

(13) Alternatively, rather than attaching the sheet of material to the helmet shell with the tubes extending inwardly therefrom, this configuration may be reversed with the ends of the tubes directly contacting the inner surface of the shell of the helmet and with the piece of material interconnecting the arrays together being located more inward toward the head of the user. Once the arrays and the sheet of material are suitably installed within the helmet, the same foam material as described earlier is installed overlying the sheet of material holding the arrays in the proper relationship with respect to one another.

(14) In a further variation, instead of installing the arrays by inserting their opposed tabs into slots formed into a piece of material, the arrays can suitably be installed by laminating them directly to the foam material at the desired locations for preferred impact attenuation, thereby omitting the step of providing a piece of material to which the arrays are first assembled. Other suitable attachment means to affix the arrays of tubes to the foam material can include rivets as well as staples and adhesives, sonic welding and heat staking.

(15) Another alternative for affixing the arrays of tubes to a piece of material to facilitate assembly in a desired configuration can consist of providing holes in the opposed tabs of each array and providing the piece of material to which the arrays are to be affixed with upwardly extending stubs or rods sized to extend through the holes in the array tabs. In order to affix the arrays to the piece of material, a heating device such as a soldering iron can be employed to melt the ends of the stubs or rods so that they spread out and lock the arrays of tubes in assembled configuration. Some welding or heat staking can also be employed.

(16) Another alternative embodiment of the present invention consists of molding a multiplicity of tubes in a single molding operation in a large mold that molds all of the tubes for a single helmet at one time in the desired configuration including integrally forming with the piece of material that provides the desired spacing and orientation. Such a one shot molding operation replaces the need to assemble a plurality of arrays of seven or ten tubes onto a piece of material using any one of the techniques and means described above.

While a preferred configuration for each tube is as disclosed in parent application Ser. No. 11/229,626, published as US/2007/0083965 A1, other tube configurations may also be contemplated. Wall configurations consisting of a plurality of connected flat sides, convoluted configurations, and other non-uniform wall thickness configurations provide effective attenuation values as disclosed herein.

Accordingly, it is a first object of the present invention to provide embodiments of a lateral displacement shock absorbing material and applications thereof.

It is a further object of the present invention to provide such material including a multiplicity of tubular members having axes of elongation aligned with one another.

It is a further object of the present invention to provide such a material in which the axes of the tubular members are maintained in alignment by virtue of webbing material integrally formed with the tubular members.

It is a still further object of the present invention to provide such a material that enhances the degree of energy absorption of a helmet structure over all known energy absorbing materials in use for helmets and other headgear.

It is a yet further object of the present invention to provide such a material in a further embodiment thereof in which the tubes are not constrained to be maintained parallel with one another but, rather, can conform to arcuate and spherical shapes such as those encountered within a helmet or on body padding.

It is a still further object of the present invention to provide such a material assembled in arrays having one or more tab(s) to facilitate installation.

It is a still further object of the present invention to assemble arrays of tubes on a piece of material for installation in a helmet or on body padding.

It is a still further object of the present invention to provide a variety of means to assemble arrays of tubes to material for positioning them in appropriate locations and orientations including stubs that are subsequently melted, tabs and slots as well as integrally molding the arrays with the piece of material in a one shot operation.

It is a still further object of the present invention to provide applications including use of a foam piece interposed between the ends of the tubes and the head of the user.

It is a yet further object of the present invention to provide the tubes in shapes including outer surfaces other than frustoconical including use of flat and arcuate circumferentially adjacent sections as well as convoluted portions.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a perspective view of a preferred embodiment of the present invention.

FIG. 2 shows a side view of the embodiment of FIG. 1.

FIG. 3 shows a top view of the embodiment of FIG. 1.

FIG. 4 shows a cross-sectional view along the line A-A of FIG. 3.

FIG. 5 shows a configuration of arrays of impact attenuation material laid out on a sheet of material prior to installation in a helmet.

FIG. 6 shows a view similar to that of FIG. 5 with the arrays having undergone a further assembly step prior to installation in a helmet.

FIG. 7 shows a view looking into a helmet from below showing a plurality of arrays of impact attenuating material assembled within the helmet.

FIG. 8 shows a view similar to that of FIG. 7, but with a foam material placed within the helmet covering the arrays of impact attenuation material.

FIG. 9 shows a reversal of parts from FIGS. 5-8 in which the material for locating the positions of the arrays of impact attenuating material is located to separate the arrays from the foam material.

FIG. 10 shows assembly of the arrays together prior to placement in a helmet.

FIG. 11 shows a view similar to that of FIG. 7 with the arrays placed in the helmet and the locating material covering the arrays.

FIG. 12 shows a further embodiment in which the arrays of impact attenuating material are laminated directly to the foam material.

FIG. 13 shows a view inverted from that of FIG. 12 showing end tabs of the arrays inserted through slots in the foam material during the lamination process.

FIG. 14 shows the assembly of FIGS. 12-13 as assembled into a helmet.

FIGS. 15-17 correspond to FIGS. 12-14, respectively, but show the arrays attached to the foam material using a further example of attachment means consisting of staples.

FIG. 18a shows a close-up view of one array of impact attenuation material with a further means for attachment to foam material consisting of posts integrally molded with the foam material inserted through holes in the tabs of the array and then melted. FIG. 18b shows details of the webbing between adjacent tubes as being slotted, both upwardly and downwardly.

FIG. 19 shows a further embodiment in which all of the arrays of impact attenuation material are molded in the desired configuration of arrays in a single molding process.

FIG. 20 shows a side perspective view of an array of impact attenuating tubes having a modified outer surface configuration.

FIG. 21 shows a top view of the array of FIG. 20.

FIG. 22 shows a side view of the array of FIGS. 20 and 21.

FIG. 23 shows a side perspective view of a further iteration of outer surface design of the impact attenuation tubes.

FIG. 24 shows a top view of the array of FIG. 23.

FIG. 25 shows a side view of the array of FIGS. 23-24.

FIG. 26 shows a side perspective view of a yet further iteration of tube design.

FIG. 27 shows a top view of the embodiment of FIG. 26.

FIG. 28 shows a side view of the embodiment of FIGS. 26-27.

### SPECIFIC DESCRIPTION OF THE PREFERRED EMBODIMENTS

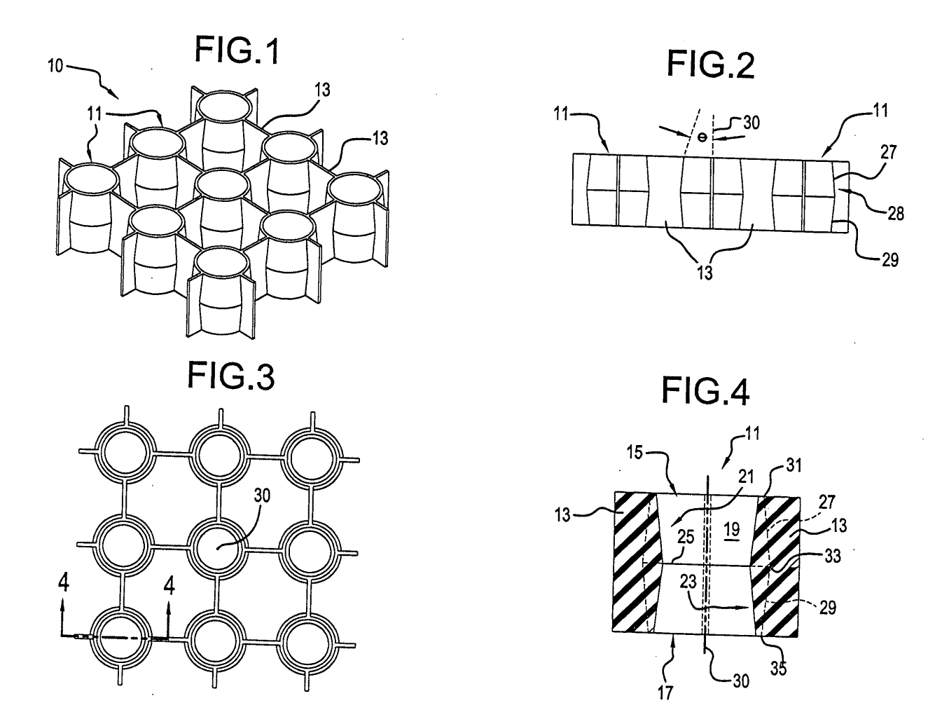

With reference first to FIG. 1, one embodiment of the structure of the present invention is generally designated by the reference numeral 10, and is seen to include a plurality of tubular members 11 interconnected with web means, webs or webbing 13 comprising means for maintaining the axes of elongation 30 of the members 11 substantially parallel. In the example shown, the tubular members are arranged in a square matrix with even spacing between one tubular member and tubular members to the sides thereof. Thus, in the example shown, one tubular member is surrounded by four adjacent tubular members at 90 degree spacing about the circumference of the centrally located tubular member 11, with each of these members being interconnected through the webbing 13. This is also shown with particular reference to FIGS. 2 and 3. Of course, any means may be employed to maintain tubular members in spaced parallel relation.

With reference to FIGS. 2 and 4, the specific details of each tubular member 11 become more evident. As seen in FIG. 4, a typical tubular member 11 includes a top opening 15, a bottom opening 17, and a passageway 19 extending therethrough. The passageway 19 consists of a first surface 21 and a second surface 23. Each of the surfaces 21 and 23 consists of a frustoconical shape. As shown in FIG. 4, the surface 21 is a frustoconical shape having its larger diameter coinciding with the upper opening or first end 15 and its smaller diameter defined by the line 25. The line 25 also defines the smaller diameter portion of the frustoconical surface 23 that terminates at a larger diameter portion defined as the lower opening or second end 17. Thus, the passageway 19 is defined by two frustoconical surfaces abutting one another at their respective smaller diameter openings.

By contrast, with reference to FIGS. 2 and 4, the tubular members 11 have outer surfaces having varying cross-sectional dimensions from the first end to the second end consisting of a first outer surface 27 and a second outer surface 29. The outer surfaces 27 and 29 each consist of frustoconical surfaces. The surface 27 comprises a frustoconical surface including an upper termination 31 defining a relatively smaller diameter surface and a lower termination 33 defining a relatively larger diameter surface. The termination 33 also defines the upper termination of the lower surface 29 with the upper termination 33 defining the larger diameter portion of the frustoconical surface 29. The lower termination of the surface 29 at 35 defines the relatively smaller diameter portion of the surface 29. Thus, the outer surface 28 of the tubular member 11 consists of two frustoconical surfaces 27 and 29 with their relatively larger diameter portions abutting one another at a central location along the axis of elongation of the tubular member 11, which axis is designated by the reference numeral 30 in FIGS. 3 and 4.

In FIG. 2, the angle θ is shown and consists of the angle between the surface 29 and the axis of elongation 30. In the preferred embodiment of the present invention, the angle θ may range from 1 to 45 degrees.

The inventive tubular members 11 and webbing 13 are made of any suitable material such as thermoplastic, for example, polypropylene, urethanes, and rubber. The inventive device 10 may be made in an injection molding process, in a pressure molding process, by casting, drape molding or machining.

The cross-section of the tubular members is shown as circular in the Figures. However, if desired, that cross-section may be polygonal, including triangular, square, pentagonal, hexagonal and octagonal as several examples.

The taper of the side walls 27, 29, 21 and 23 allows the inventive material to have a variable tunable crush ability. Use of a double taper, inside taper, outside taper or any combination thereof may be used depending upon the particular situation. The example shown includes both inner and outer double tapers. In the prior art, multi-impact attenuation products typically exhibit non-uniform resistance to crush, require a high load to start the crush process, and commencement of the crush process is typically followed by a non-uniform collapse. Applicants have found that the present invention as contemplated allows for a softer initial resistance followed by an increase in crush resistance as the material is compressed, thereby exhibiting a somewhat uniform resistance throughout a wide range of crushing activity.

If desired, the inside walls of the tubular members may be slightly tapered as shown in the Figures to allow the materials to roll inside as they collapse, thereby giving a shorter, completely collapsed height to the product. In use, the tubular members absorb and dampen impact rather than acting like springs and do not rebound energy as is the case in spring-like materials. Through dampened rebound characteristics, the material does not act like a bouncing ball which just returns energy from the impacting object.

Enhanced consistency is achieved through the preferred manner of manufacture, namely, injection molding. The present invention with its tubular members open completely therethrough enhances ventilation of a helmet or body padding in which they are installed. Airflow through the tubular members and past the webbing is virtually unrestricted.

Through changes in the density and durometer of the material, impact absorbing characteristics can appropriately be modified. In the preferred embodiments of the present invention, the material exhibits a durometer in the range of 20 to 120 on the Shore A hardness scale. By shortening the widths of the webbing 13 and thereby locating the tubular members 11 closer together, enhanced impact absorption characteristics result so long as sufficient spacing between adjacent tubes is maintained to allow each tube to collapse in length while expanding radially outwardly without restriction. Applicants have found that as a result of use of the teachings of the present invention, impact absorption can be enhanced by a factor of 50 to 75% over known impact absorbing materials.

In the preferred embodiments of the present invention, the elasticity of the materials from which the tubular members are made may range between 5 and 2,000%. Applicants have found that use of multi-tapered walls such as those shown in FIGS. 1-4 results in a cascading impact absorbing effect. That is, when the tubular members are compressed, a second taper starts to bulge after a first taper has been compressed to the point where it starts to stiffen, and this process continues on through third and fourth tapers in a cascading order. While the example shown includes inner and outer tapered surfaces that are mirror images of one another, as best seen with reference to FIG. 4, it is not necessary that the mirror image configuration shown in FIG. 4 be employed.

The webbing 13 can play a role in impact attenuation. Prevention of interference of the webbing 13 with impact attenuation may be accomplished by attaching web structures to one end of a tubular member 11 only, by attaching the webbing 13 at both ends of a tubular member 11, by attaching the webbing 13 the full length from the top to the bottom of the tubular member or any fraction of that length, by making the webbing 13 of a multi-part construction, or by making the webbing convoluted in shape such as, for example, with a S-shaped cross-section. Of course, one important factor is to design the webbing and tubular members so that the entire assembly may be molded in a substantially linear movement of tooling halves to minimize the cost of tooling.

Applicants have found that certain variations in the configurations of the tubes forming impact attenuation arrays achieve effective impact attenuation. Additionally, Applicants have developed a variety of ways to employ impact attenuation arrays in accordance with the teachings of the present invention, particularly in the environment of sporting helmets.

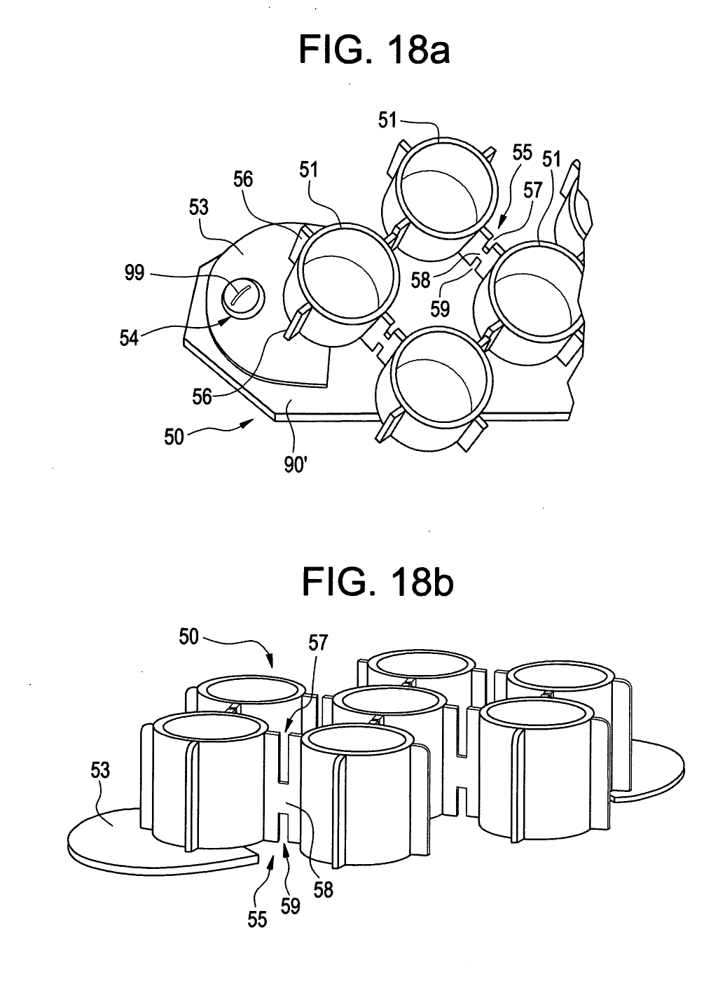

In the embodiment illustrated in FIGS. 1-4, forming a part of the parent application, the webbing 13 between adjacent tubes 11 was designed and intended to maintain the axes of elongation 30 of the respective tubes 11 parallel to one another. Applicants have found that designing the webbing to permit individual tubes to better conform to the arcuate or spherical surface of the inside of a helmet renders the arrays of tubes more effective in impact attenuation. In this regard, reference is made to FIGS. 18a and 18b which show a portion of an array 50 of tubes 51. The array includes an end tab 53 facilitating installation of the array 50 as will be explained in greater detail subsequently.

As shown in FIGS. 18a and 18b, adjacent tubes 51 are interconnected by virtue of webbing 55. As shown, the webbing includes an upwardly facing slot 57 and a downwardly facing slot 59. Alternatively, one or the other of these slots may be omitted. As should be understood, the slots 57 and 59 permit adjacent tubes 51 to pivot with respect to one another to accommodate to the arcuate or spherical inner surface of a helmet, as described in greater detail hereinafter. In this way, the axis of elongation of each tube 51 may be oriented to be perpendicular to a tangent of the location on the helmet where the tube is located so that impacts are likely to be transferred to the tubes 51 along their axis of elongation. As also shown in FIGS. 18a and 18b, each web 55 includes a horizontally directed strengthening rib 58 which strengthens the web 55 so that it can perform the function of holding together adjacent tubes 51 in an array such as shown, for example, in FIGS. 18a and 18b. Some of the tubes 51 have elongated vertically extending reinforcing ribs 56.

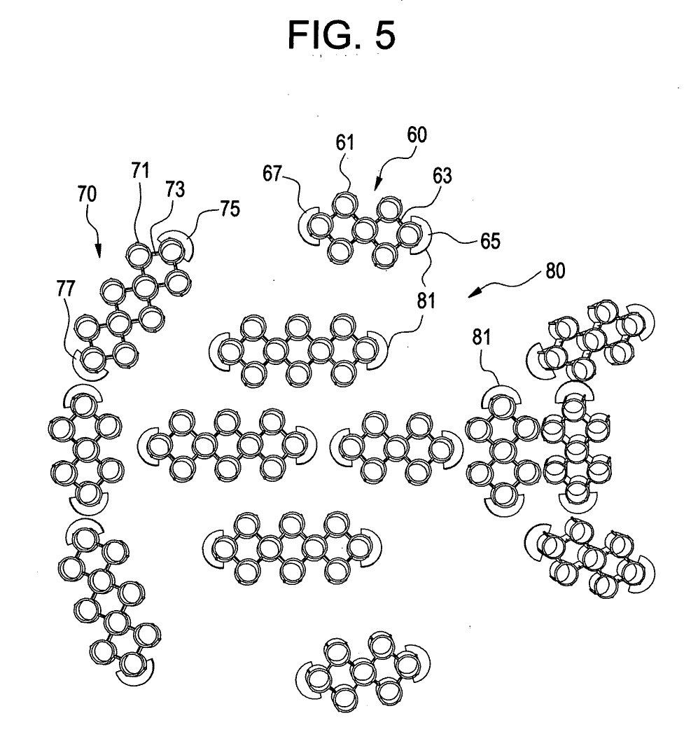

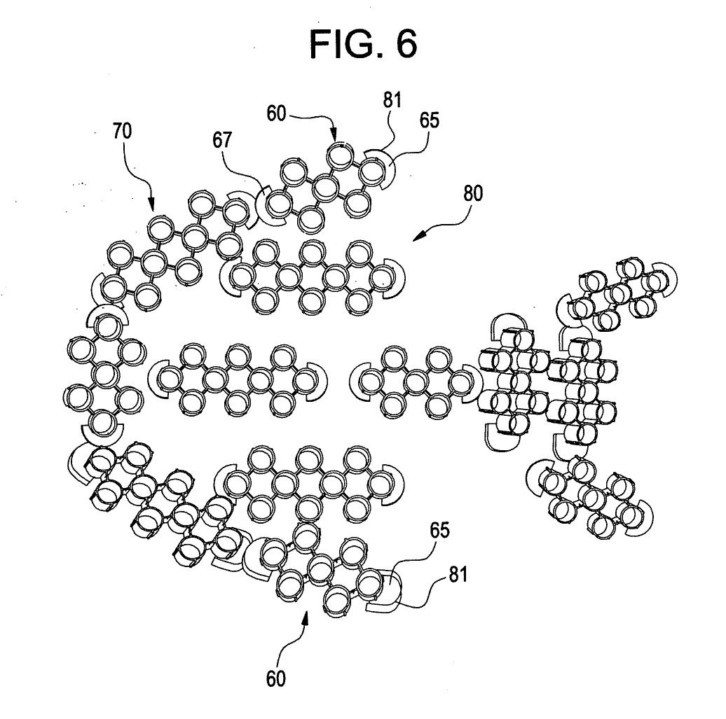

With reference now to FIGS. 5-8, a first application of the inventive impact attenuation arrays will be described in detail. As seen in FIG. 5, two configures of arrays are provided, a first configuration 60 including seven tubes 61 held together by webbing 63, with the array 60 including opposed tabs 65 and 67 for installation purposes. A second configuration of array 70 includes ten tubes 71 held together by webbing 73 and including opposed tabs 75 and 77 to facilitate assembly of each array to a flexible piece of material shown in FIGS. 5 and 6 in particular and designated by the reference numeral 80.

The piece of material 80 consists of, in a preferred embodiment, a transparent material so that when the assembled arrays 60 and 70 are to be installed within a helmet, the installer can see through the material 80 to properly align the arrays 60 and 70 within the helmet. The material 80 includes a plurality of slots 81 which are located to receive tabs 65, 67, 75 and 77 to preliminarily locate the arrays 60 and 70 in a configuration such as shown in FIGS. 5 and 6. One of the slots 81 for receiving a tab 65 of an array 60 is clearly seen at the lower portion of FIG. 6.

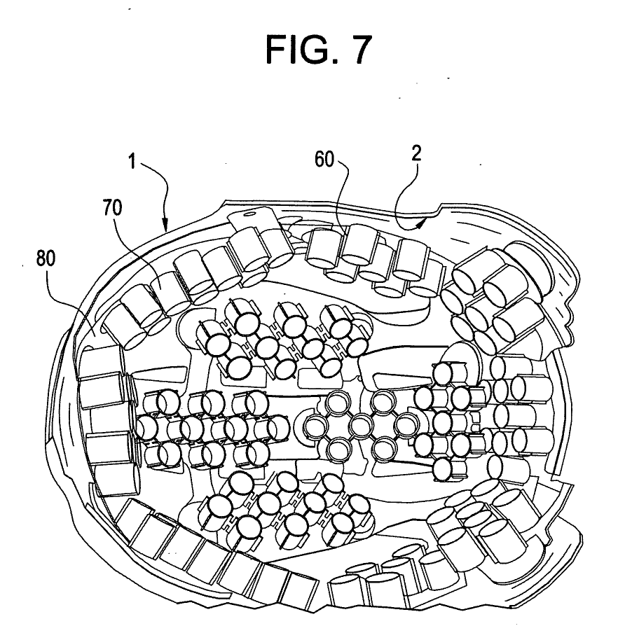

FIG. 7 shows a helmet 1 having an inner surface 2 that is arcuate, conforming to the shape of the human head. FIG. 7 shows the material 80 with the arrays 60 and 70 installed therein, with the arrays located in the appropriate strategic locations to provide impact attenuation.

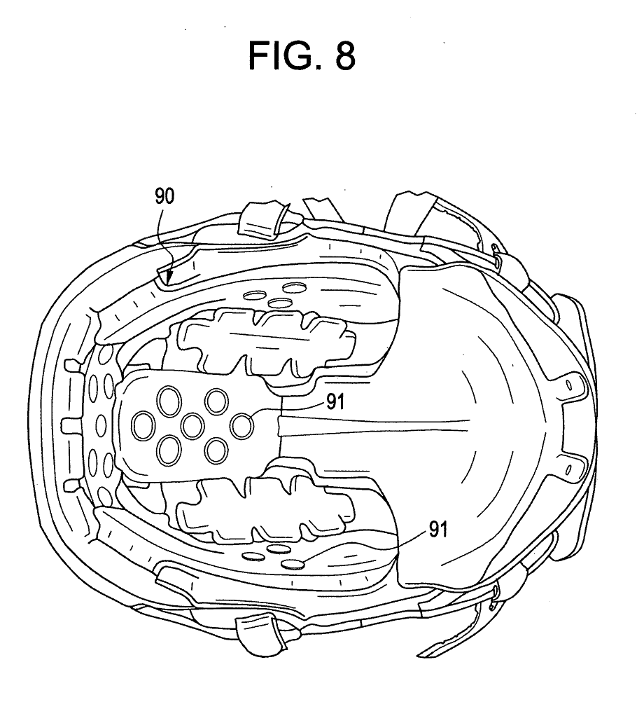

FIG. 8 shows a comfort liner or fit foam 90 that overlies all of the arrays 60 and 70 so that they do not directly engage the head of the user. In the preferred embodiment of the fit foam 90, it is provided in a dual density configuration with the softer density nearer to the location of engagement with the head of the wearer and with the harder density engaging the ends of the tubes of the arrays 60, 70. As shown in FIG. 8, the liner 90 includes circular areas 91 that help the installer locate the arrays 60, 70 so that they may be accurately installed within the fit foam liner 90. The webbing holding together adjacent tubes is slotted as shown in FIG. 18 so the axes of elongation of the tubes are perpendicular to a tangent of the helmet at that location to ensure that impacts on the helmet are transferred to the tubes axially. This is equally the case for the applications of the inventive arrays to helmets as set forth below.

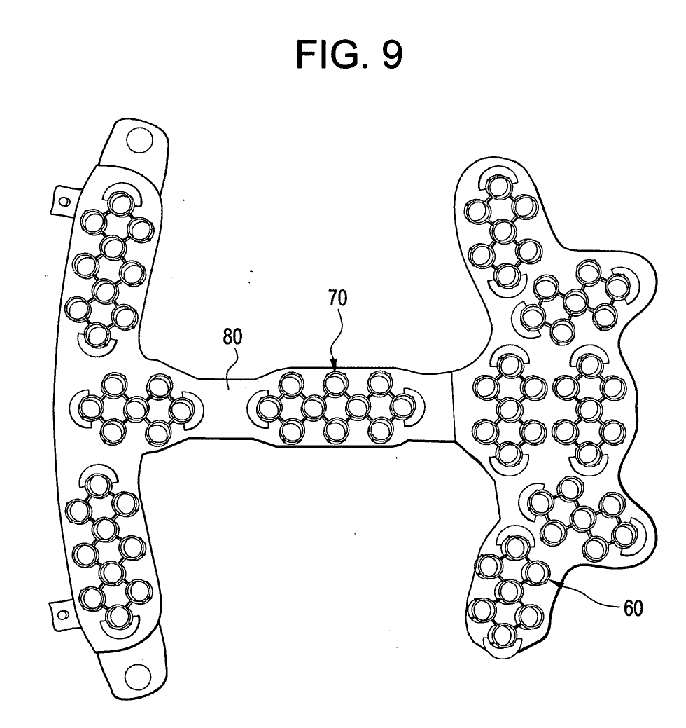

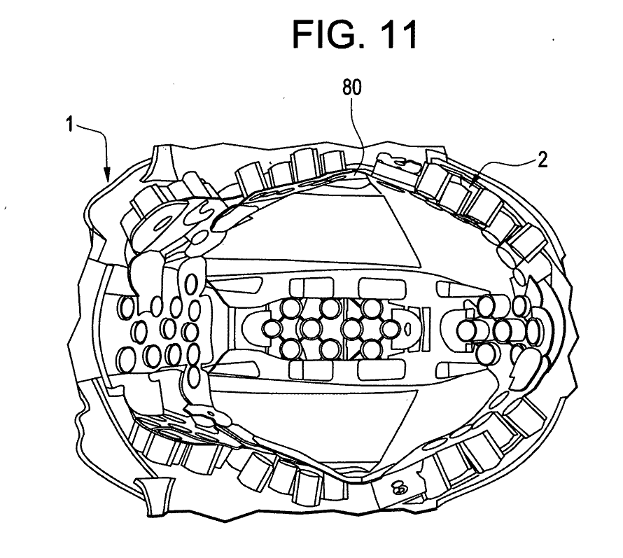

With reference to FIGS. 9-11, a further application of the inventive impact attenuation arrays is seen, in which the piece of material 80 is inverted with respect to the arrays of tubes. In other words, in the configuration shown, the arrays 60 and 70 are assembled to the piece of material 80 in such a manner that the arrays 60 and 70 will engage the inner surface 2 of the helmet 1 (FIG. 11) with the piece of material 80 being positioned to engage the fit foam material shown in FIG. 8.

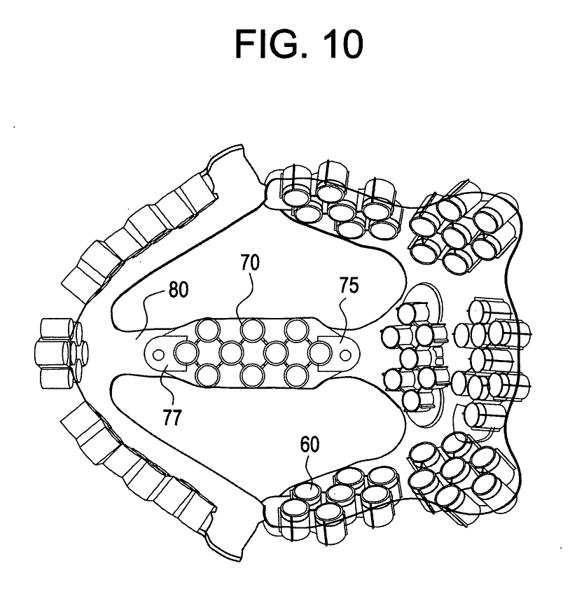

FIG. 10 shows a clear view of the piece of material 80 as well as the arrays 60, 70. In the middle of FIG. 10, the array 70 is clearly seen with its tabs 75 and 77 extending through slots in the material 80 to facilitate installation and location of the arrays 60 and 70.

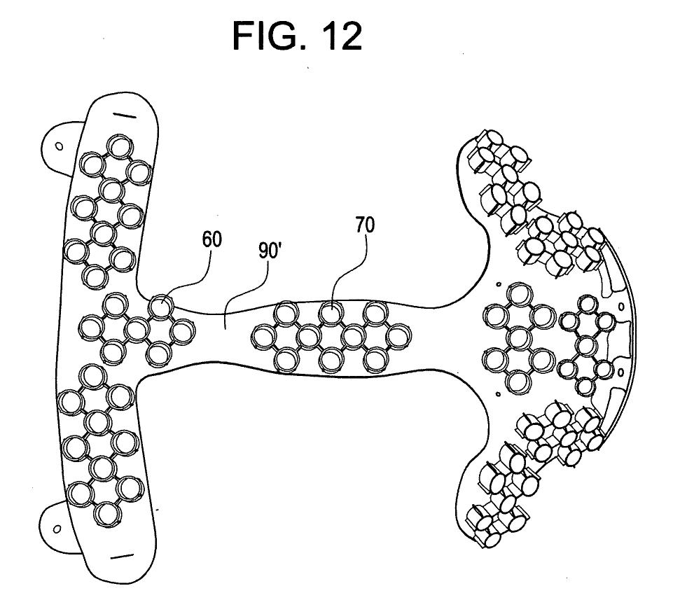

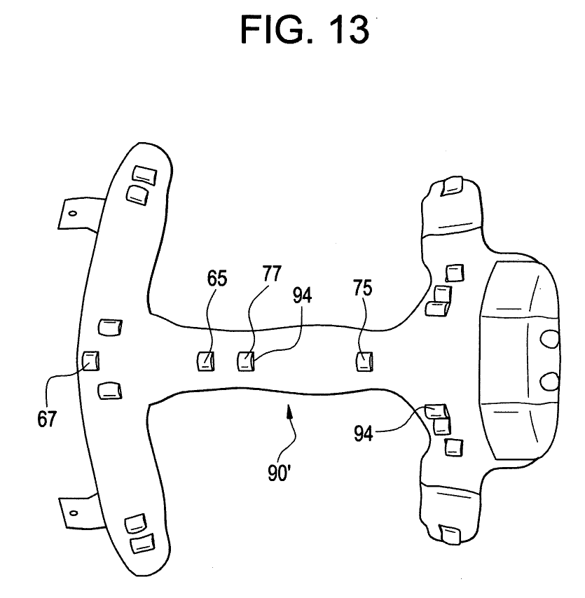

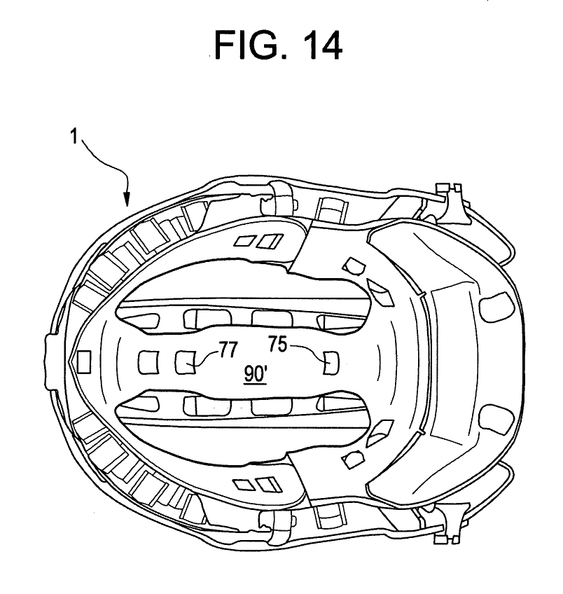

With reference to FIGS. 12, 13 and 14, in another application, the arrays are directly installed on the fit foam and are laminated thereto. FIG. 12 shows the fit foam 90′ and a plurality of arrays 60 and 70 assembled thereto. As seen in FIG. 13, slots 94 are formed in the fit foam 90′ and the tabs, for example, 65, 67 of the arrays 60 and 75, 77 of the arrays 70, are inserted through the slots 94 and are suitably laminated to affix the arrays 60, 70 in the orientation shown in FIG. 12. Then, the fit foam 90′ is inverted and installed in the helmet 1 as shown in FIG. 14. The difference between the comfort liner or fit foam 90′ and the comfort liner or fit foam 90 is that the liner 90′ may be constructed of a single density as compared to the multiple densities of the liner 90 as explained above.

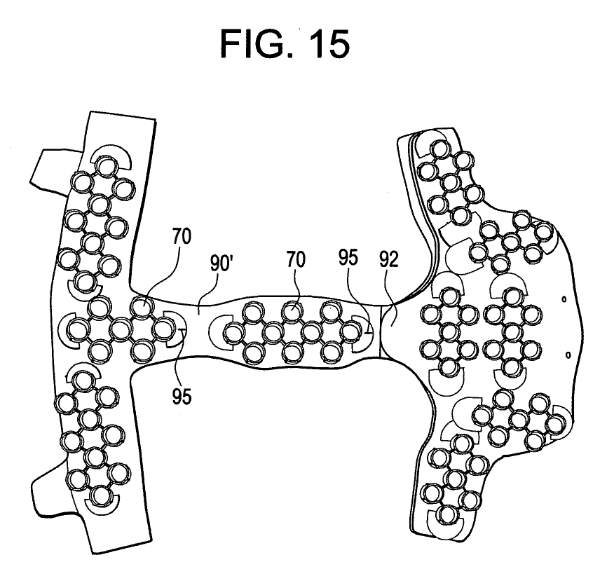

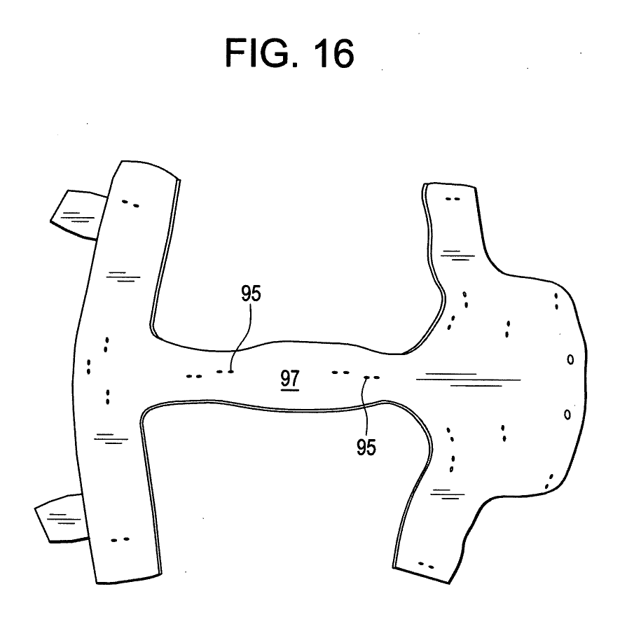

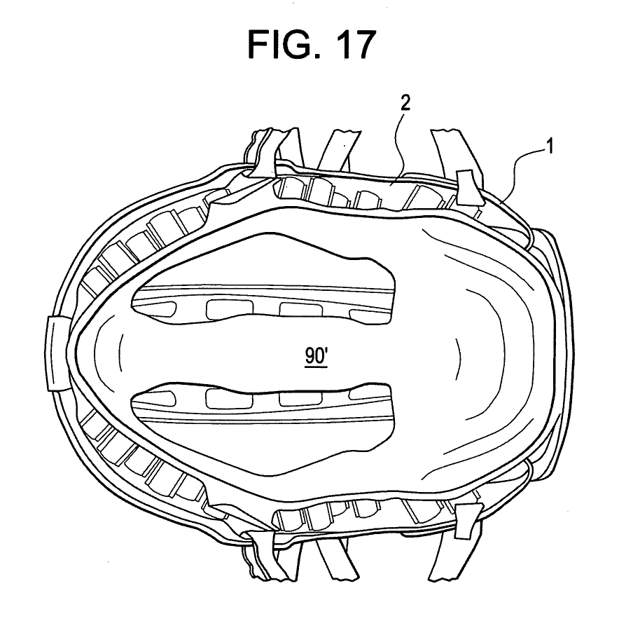

FIGS. 15-17 show a variation of the embodiment of FIGS. 12-14. In FIGS. 15-17, the arrays 60, 70 are affixed to the surface 92 of the fit foam 90′ using staples 95. FIG. 16 shows the staples 95 slightly protruding from the side 97 of the fit foam 90′. The arrays, after being stapled, are preferably sonically welded to the surface 92 of the fit foam 90′.

With reference to FIG. 18, the tab 53 of the array 50 has a hole 54 therein through which a stem 99 integrally formed with the fit foam 90′ protrudes. As shown in FIG. 18, the end of the stem 99 has been melted to act like a rivet spreading over the surface of the tab 53 and locking the tab 53 and the array 50 onto the fit foam 90′.

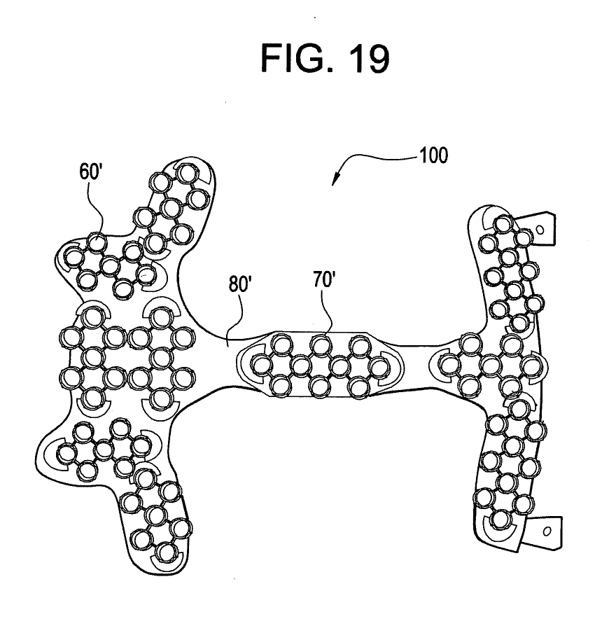

FIG. 19 shows a schematic representation of a plurality of arrays 60′ and 70′ as well as a piece of material 80′. FIG. 19 shows these elements integrally molded in a single molding operation that eliminates the necessity to assemble the components together. In so doing, one tool in an injection molding machine is provided with runners connecting the arrays 60′ and 70′ as molded so that they are in the precise, correct orientation. After molding, the fit foam material (not shown) is assembled to the one piece molded configuration 100 and assembled to the helmet as earlier shown.

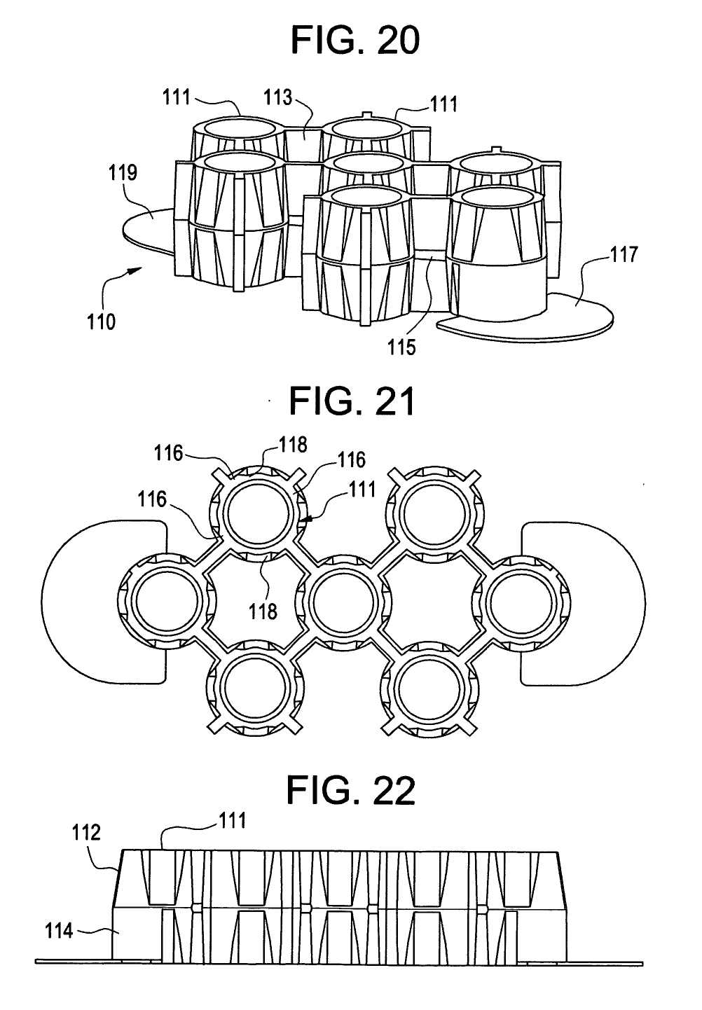

FIGS. 20-28 depict three differing variations on the outer wall configuration of the tubes of the inventive arrays. In the embodiment illustrated in FIGS. 1-4 and comprising the disclosure of the parent application, the outer surfaces of the tubes consist of two frustoconical surfaces 27 and 29, with their larger diameter terminations abutting one another at 33 as seen in FIG. 4.

With reference to FIGS. 20-22, an array 110 is composed of a plurality of tubes 111 held together by webbing 113 which may be solid webbing or slotted as described above with reference to FIG. 18. The webbing has a horizontal reinforcing rib 115 as explained above. Additionally, tabs 117 and 119 facilitate installation on pieces of material such as those identified above by reference numerals 80 and 80′ to facilitate installation into, for example, a helmet. As seen in particular in FIGS. 20 and 22, the outer walls 112 and 114 of each tube 111 generally taper from a smaller diameter at the ends thereof to a larger diameter at their common intersection. However, the periphery of the ends of the tubes and walls has a configuration, best seen in FIG. 21, to include generally convex or flat surfaces 116 and generally concave surfaces 118, which also undulate as clearly shown in FIG. 21.

As seen in FIG. 21, the generally convex or flat surfaces 116 are four in number for each tube 111.

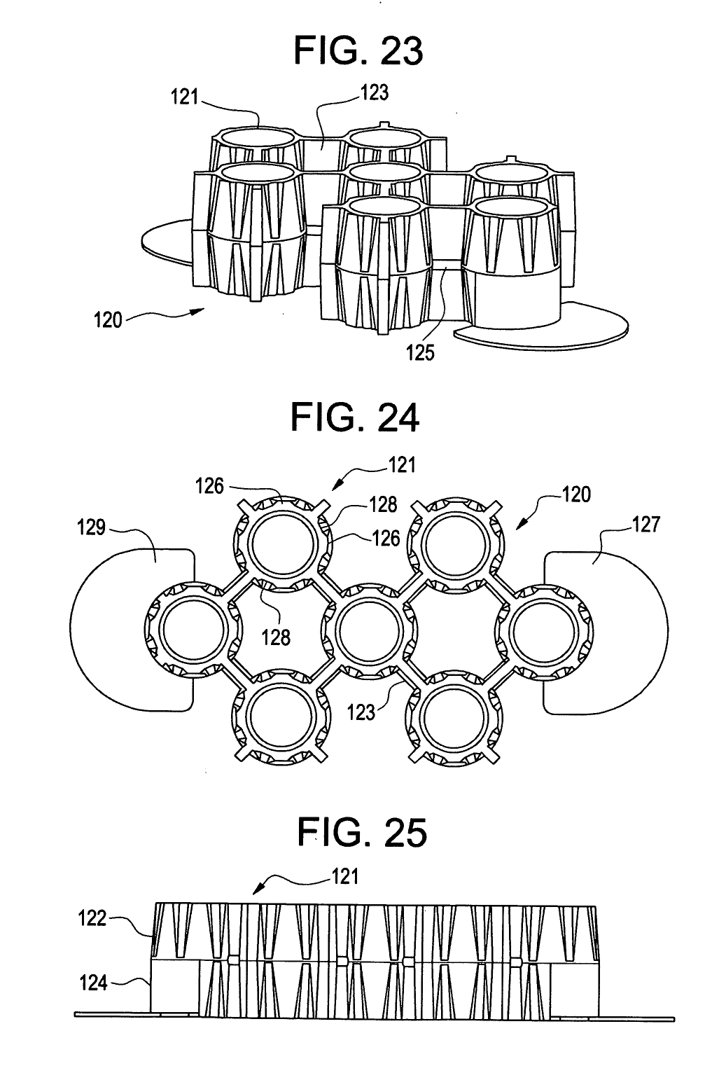

By contrast, in the embodiment of FIGS. 23-25, an array 120 includes a plurality of tubes 121 assembled together using webbing 123 which may or may not be slotted as shown in FIG. 18. The webbing includes horizontally extending reinforcing rib 125 for each one. Comparing FIGS. 22 and 25, again, the tubes 121 have outer surfaces 122, 124 that generally taper from a smaller diameter at the ends of the tubes toward a larger diameter at the intersection of the walls 122-124.

Comparing FIGS. 21 and 24, it is seen that in the tubes 121, there are eight generally convex or flat surfaces 126 between which concave surfaces 128 are provided. The ends of the tubes are correspondingly configured as shown. Tabs 127 and 129 serve the same purpose as the tabs 117 and 119.

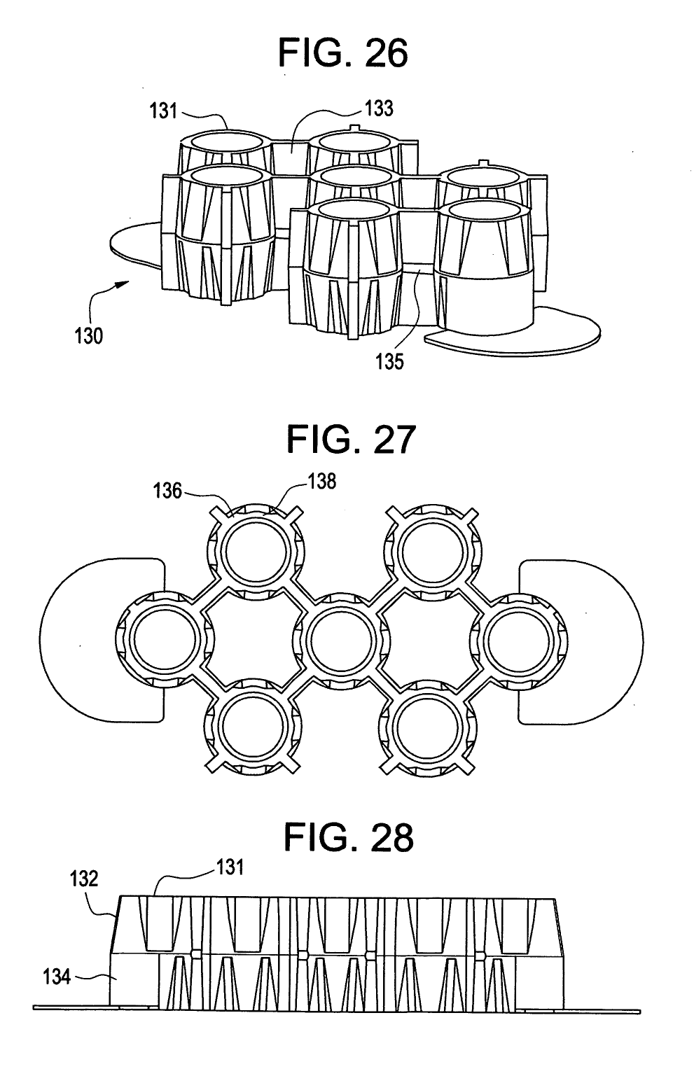

With reference now to FIGS. 26-28, an array 130 is seen to include a plurality of tubes 131 interconnected together with webbing 133 which includes horizontally disposed reinforcing ribs 135. As before, if desired, the webbing 133 may be slotted as shown in FIG. 18.

With reference to FIG. 28, as is the case with regard to FIGS. 20-25, the tubes 131 have side walls 132, 134 that taper from smaller diameter portions at the ends of the tubes to larger diameter portions where they interconnect. The embodiment of FIGS. 26-28 is similar to that of the embodiment of FIGS. 20-22. However, comparing the surfaces 118 shown in FIG. 21 with the surfaces 138 shown in FIG. 27, there is a slight difference in the undulation of those surfaces. The ends of the tubes incorporate those slight differences in their peripheries as shown.

As such, an invention has been disclosed in terms of preferred embodiments thereof which fulfill each and every one of the objects of the invention as set forth hereinabove, and provide new and useful embodiments of lateral displacement shock absorbing material and applications thereof of great novelty and utility.

Of course, various changes, modifications and alterations in the teachings of the present invention may be contemplated by those of ordinary skill in the art without departing from the intended spirit and scope thereof.

As such, it is intended that the present invention only be limited by the terms of the appended claims.

1. A shock absorbing structure, comprising:
a) a plurality of tubular members spaced apart, each tubular member including:
i) an axis of elongation;
ii) an internal passageway having an inner surface and extending through a said tubular member from a first end of said tubular member to a second end thereof;
iii) an outer surface having varying cross-sectional dimensions from said first end to said second end; and
b) web means for interconnecting adjacent tubular members.

2. The structure of claim 1, wherein said tubular members are interconnected into an array by said web means.

3. The structure of claim 2, wherein said array includes 7 tubular members.

4. The structure of claim 2, wherein said array includes 10 tubular members.

5. The structure of claim 2, wherein said array includes at least one tab for facilitating installation of said array at a location for providing shock absorbing action.

6. The structure of claim 5, wherein said at least one tab has a hole therethrough to facilitate said installation.

7. The structure of claim 1, wherein said web means comprises webbing interconnecting adjacent tubular members, said webbing being slotted.

8. The structure of claim 7, wherein said webbing includes a slot extending for a portion of its length.

9. The structure of claim 8, wherein said portion comprises less than half the length of said webbing.

10. The structure of claim 7, wherein said webbing includes two opposed slots having terminations spaced apart.

11. The structure of claim 10, wherein said webbing includes a horizontal reinforcement rib between said terminations of said slots.

12. A plurality of arrays as claimed in claim 2 and a piece of flexible material to which said arrays are connected.

13. The invention of claim 12, wherein said piece of flexible material with said arrays connected thereto is installed within a helmet.

14. The invention of claim 13, wherein said piece of flexible material engages an inner surface of said helmet.

15. The invention of claim 13, wherein said tubular members engage an inner surface of said helmet.

16. The invention of claim 13, further including a comfort liner overlying said piece of flexible material and said arrays.

17. The invention of claim 12, wherein each array includes spaced tabs received in spaced slots in said flexible material.

18. The invention of claim 12, wherein said flexible material includes spaced upstanding posts, each array including spaced tabs, each tab having a hole receiving a post, each said post being fastened to a respective tab.

19. The invention of claim 12, wherein said arrays are connected to said flexible material with staples.

20. The invention of claim 12, wherein said arrays are laminated to said flexible material.

21. The invention of claim 12, comprising a one-piece molded assembly.

22. A shock absorbing structure, comprising:
a) a plurality of tubular members spaced apart, each tubular member including:
i) an axis of elongation;
ii) an internal passageway having an inner surface and extending through a said tubular member from a first end of said tubular member to a second end thereof;
iii) an outer surface having varying cross-sectional dimensions from said first end to said second end with a largest cross-sectional dimension between said ends; and
b) web means for interconnecting adjacent tubular members to form an array.

23. The structure of claim 22, wherein said web means comprises webbing interconnecting adjacent tubular members, said webbing being slotted.

24. The structure of claim 23, wherein said webbing includes a slot extending for a portion of its length.

25. The structure of claim 24, wherein said portion comprises less than half the length of said webbing.

26. The structure of claim 23, wherein said webbing includes two opposed slots having terminations spaced apart.

27. The structure of claim 26, wherein said webbing includes a horizontal reinforcement rib between said terminations of said slots.

28. The structure of claim 22, wherein said outer surface has a smallest cross-sectional dimension at each end.

29. The structure of claim 28, wherein a periphery of each end of each tubular member includes a plurality of spaced straight sections.

30. The structure of claim 29, wherein said plurality of spaced straight sections comprises 4 sections.

31. The structure of claim 29, wherein said plurality of spaced straight sections comprises 8 sections.

32. The structure of claim 29, wherein said periphery includes undulating sections between adjacent straight sections.

33. The structure of claim 22, wherein some of said tubular members include outwardly extending reinforcing ribs.
